(19) United States
(12) Patent Application Publication
(10) Pub. No.: US 2015/0308369 A1
(43) Pub. Date: Oct. 29, 2015

(54) CYLINDER HEAD OF MULTI-CYLINDER INTERNAL COMBUSTION ENGINE

(71) Applicants: Kohei KODAMA, (US); Hideo NAKAMURA, (US)

(72) Inventors: Kohei KODAMA, Toyota-shi (JP); Hideo NAKAMURA, Toyota-shi (JP)

(73) Assignee: TOYOTA JIDOSHA KABUSHIKI KAISHA, Toyota-shi (JP)

(21) Appl. No.: 14/649,010

(22) PCT Filed: Dec. 6, 2012
(86) PCT No.: PCT/JP2012/081698

§ 371 Date: Jun. 2, 2015

(51) Int. Cl. F02F 1/42

(52) U.S. Cl. CPC F02F 1/4264

(57) ABSTRACT

A cylinder head for a multi-cylinder internal combustion engine includes a plurality of exhaust ports provided for each of a plurality of cylinders arranged in line. The plurality of exhaust ports corresponding to each of the plurality of cylinders converge at a convergent portion at a downstream side. The exhaust ports respectively corresponding to at least two of the plurality of cylinders converge at the convergent portion.

### TECHNICAL FIELD

The present invention relates to a cylinder head for a multi-cylinder internal combustion engine.

### BACKGROUND ART

Patent Document 1 describes a known cylinder head for a multi-cylinder internal combustion engine. The cylinder head includes an exhaust port provided for each of a plurality of cylinders that are arranged in line. The exhaust ports of the cylinders converge at a downstream position. Patent Document 2 describes a plurality of exhaust ports that are provided for each cylinder. The exhaust ports corresponding to each cylinder converge at a downstream position. In a cylinder head that includes a plurality of exhaust ports for each cylinder such as that disclosed in Patent Document 2, the exhaust ports corresponding to each cylinder converge at a downstream position to form a convergent exhaust port, and the convergent exhaust ports respectively corresponding to the cylinders converge at a further downstream position.

### PRIOR ART DOCUMENT

### Patent Documents

Patent Document 1: Japanese Laid-Open Patent Publication No. 2007-285168

Patent Document 2: Japanese Laid-Open Patent Publication No. 2009-68399

### SUMMARY OF THE INVENTION

### Problems That are to be Solved by the Invention

In the above cylinder head, it is desired that the flow velocity of exhaust that passes through the exhaust port of each cylinder be increased to reduce the temperature of the exhaust. The cross-sectional area of the exhaust port may be decreased to reduce the temperature. However, it is inevitable that the cross-sectional area of the exhaust port is increased at a downstream portion where exhaust ports corresponding to each cylinder converge (hereinafter referred to as an individual cylinder convergent portion) and a downstream portion where convergent exhaust ports extending from the individual cylinder convergent portions corresponding to the cylinders further converge (hereinafter referred to as an inter-cylinder convergent portion). Thus, the cross-sectional area of the exhaust port increases at the individual cylinder convergent portion and then decreases. The cross-sectional area of the exhaust port increases toward the downstream again at the inter-cylinder convergent portion and then decreases. When exhaust flowing through the exhaust port sequentially passes through the individual cylinder convergent portion and the inter-cylinder convergent portion, the increase and decrease of the cross-sectional area of the exhaust port in each convergent portion accordingly varies, that is, increases and decreases, the flow velocity of the exhaust. The variation, that is, repeated increase and decrease, of the flow velocity of exhaust increases the proportion of the sections where the flow velocity of exhaust decreases in the entire exhaust path. Thus, it is difficult to effectively reduce the temperature of exhaust by increasing the flow velocity of the exhaust.

It is an object of the present invention to provide a cylinder head for a multi-cylinder internal combustion engine capable of effectively reducing the temperature of exhaust by increasing the flow velocity of the exhaust flowing through an exhaust port.

### Means for Solving the Problem

The means for solving the problem and the advantages of the present invention will be described in the following.

A cylinder head for a multi-cylinder internal combustion engine that solves the problem is configured so that a plurality of exhaust ports corresponding to each of a plurality of cylinders arranged in line converge at a convergent portion at a downstream side and that the exhaust ports respectively corresponding to at least two of the plurality of cylinders converge at the convergent portion.

The cross-sectional area of the exhaust ports increases at the convergent portion toward the downstream side of the exhaust ports and then decreases. The flow velocity of the exhaust is varied by increases and decreases in the cross-sectional area of the exhaust ports. The flow velocity of the exhaust is varied only once when the exhaust flows through the exhaust ports. This limits increases in the proportion of sections where the flow velocity of exhaust decreases in the entire exhaust path, which would be caused by repeated variation, that is, increases and decreases, in the flow velocity of the exhaust flowing through the exhaust ports. Thus, factors that lower the flow velocity of the exhaust are reduced. This limits situations in which the exhaust temperature cannot be effectively reduced when the flow velocity of the exhaust flowing through the exhaust ports cannot be easily increased as described above. It is therefore possible to effectively reduce the temperature of the exhaust.

The multi-cylinder internal combustion engine is an internal combustion engine including four cylinders arranged in line, that is, an inline-four cylinder internal combustion engine. The multi-cylinder internal combustion engine may be configured so that the exhaust ports corresponding to two middle ones of the four cylinders, in a direction in which the four cylinders are arranged, converge at the convergent portion.

The convergent portion where the exhaust ports corresponding to the two middle cylinders, in the direction in which the four cylinders are arranged, converge is a first convergent portion. The exhaust ports corresponding to two of the cylinders located at the two ends, in the direction in which the four cylinders are arranged, may converge at a second convergent portion, which is located at a downstream side and separated from the first convergent portion in an axial direction of the cylinders. A distance from combustion chambers of the two middle cylinders to the first convergent portion is shorter than a distance from combustion chambers of the two end cylinders to the second convergent portion.

### BRIEF DESCRIPTION OF THE DRAWINGS

FIG. 1 is a plan view schematically showing the structure of an exhaust port in a cylinder head for a multi-cylinder internal combustion engine.

FIG. 2 is a front view schematically showing the structure of the exhaust port.

FIG. 3 is a plan view schematically showing a comparative example of the structure of the exhaust port.

FIG. 4 is a graph showing changes in the cross-sectional area of an exhaust port in correspondence with the distance from a combustion chamber in an exhaust port.

### EMBODIMENTS OF THE INVENTION

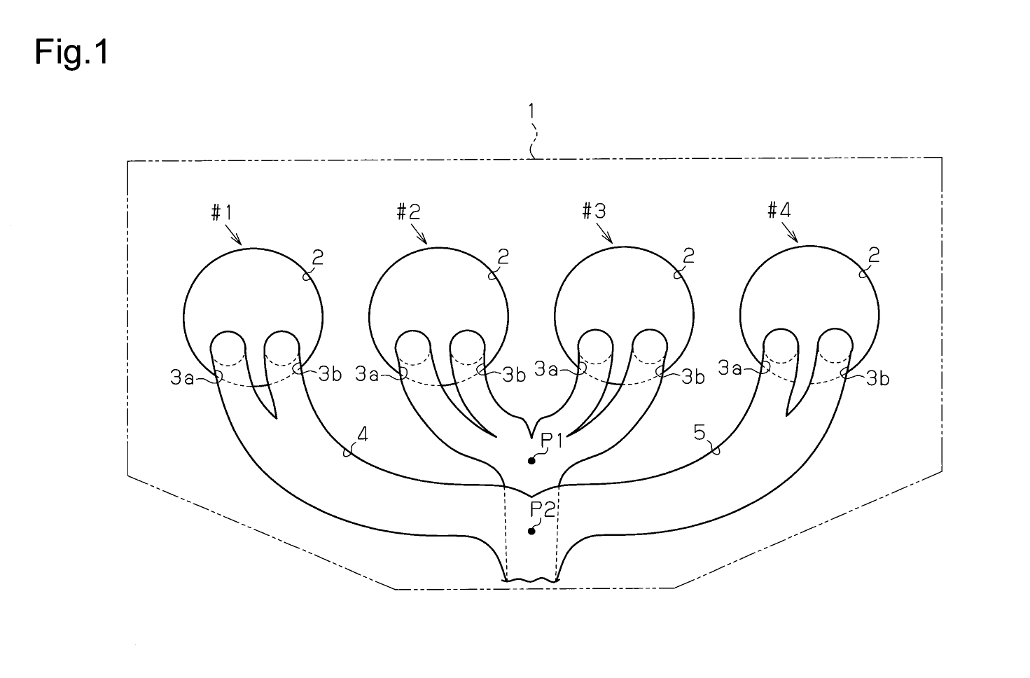

One embodiment of a cylinder head for a multi-cylinder internal combustion engine will now be described with reference to FIGS. 1 to 4.

FIG. 1 schematically shows exhaust ports of a cylinder head 1 in a multi-cylinder internal combustion engine, more specifically, an inline-four cylinder internal combustion engine. The cylinder head 1 includes a plurality of exhaust ports 3a and 3b for each of four cylinders #1 to #4 arranged in line (in this example, two exhaust ports are provided for one cylinder). The exhaust ports 3a and 3b are each connected to a combustion chamber 2 of the corresponding cylinder.

In the cylinder head 1, the exhaust ports 3a and 3b of the first cylinder #1 converge at a downstream position in a flow direction of exhaust to form a convergent exhaust port 4, and the exhaust ports 3a and 3b of the fourth cylinder #4 converge at a downstream position in a flow direction of exhaust to form a convergent exhaust port 5. The convergent exhaust port 4 of the first cylinder #1 and the convergent exhaust port 5 of the fourth cylinder #4 converge at a further downstream position (position P2). Position P2 is set at the middle of the first to fourth cylinders #1 to #4 in the direction in which the cylinders #1 to 4 are arranged, that is, a portion corresponding to between the second cylinder #2 and the third cylinder #3.

In the cylinder head 1, the exhaust ports 3a and 3b of the second cylinder #2 converge at a downstream position (position P1), and the exhaust ports 3a and 3b of the third cylinder #3 converge at a downstream position (position P1). The exhaust ports of the cylinders #2 and #3, that is, the exhaust ports 3a and 3b of the second cylinder #2 and the exhaust ports 3a and 3b of the third cylinder #3 converge at position Pl. Position P1 is set at the middle of the first to fourth cylinders #1 to #4 in the direction in which the cylinders #1 to #4 are arranged, that is, a portion corresponding to between the second cylinder #2 and the third cylinder #3.

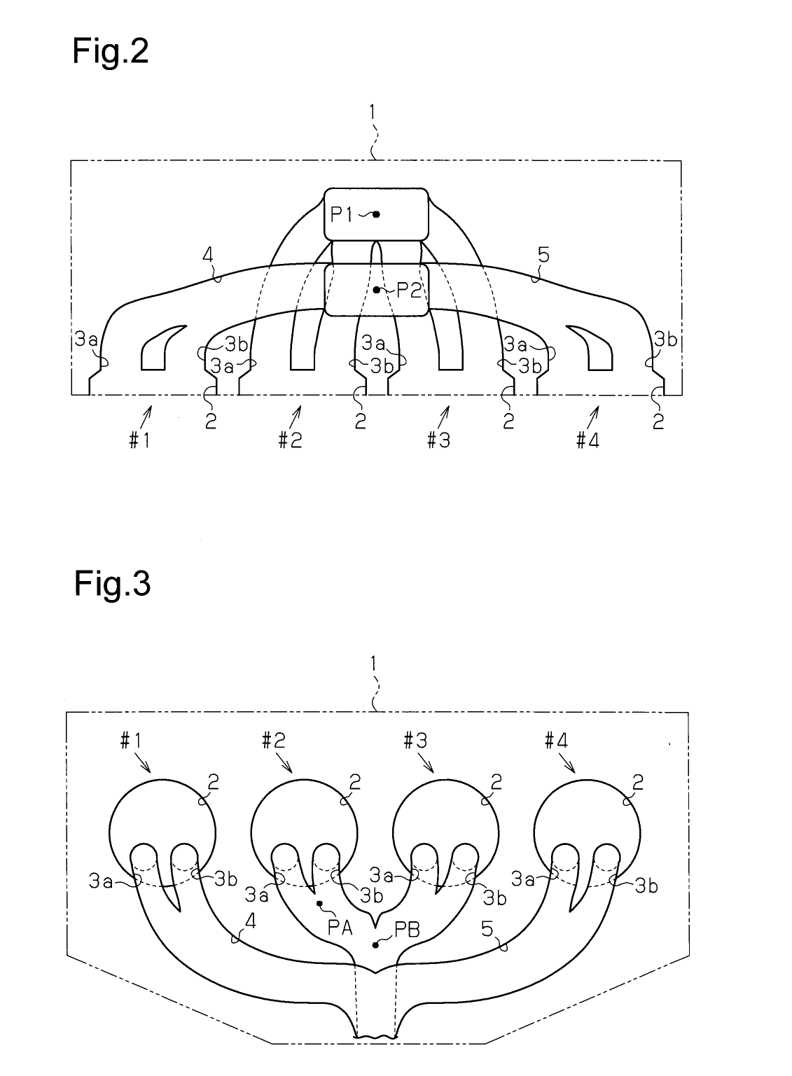

As shown in FIG. 2, position P1 is separated from position P2 toward the upper side. The vertical direction of FIG. 2 is an axial direction of the first to fourth cylinders #1 to #4 (movement direction of pistons, which are not shown). The portion corresponding to position P1 in the exhaust ports 3a and 3b of the second cylinder #2 and the third cylinders #3 is a convergent portion (hereinafter referred to as a first convergent portion) in which the exhaust ports 3a and 3b of the two cylinders #2 and #3 converge. The two cylinders #2 and #3 are located in the middle in a direction in which the first to fourth cylinders #1 to #4 are arranged. The portion corresponding to position P2 in the convergent exhaust ports 4 and 5 of the first cylinder #1 and the fourth cylinder #4 is a convergent portion (hereinafter referred to as a second convergent portion) in which the convergent exhaust ports 4 and 5 of the cylinders #1 and #4 converge. The cylinders #1 and #4 are located at the two ends in a direction in which the first to fourth cylinders #1 to #4 are arranged.

The second convergent portion is separated from the first convergent portion in the axial direction of the first to fourth cylinders #1 to #4. The distance from the combustion chambers 2 of the second cylinder #2 and the third cylinder #3 to the first convergent portion is shorter than the distance from the combustion chambers 2 of the first cylinder #1 and the fourth cylinder #4 to the second convergent portion. In other words, the distance from the combustion chamber 2 to the first convergent portion in the exhaust ports 3a and 3b of the second cylinder #2 and the third cylinder #3 is shorter than the distance from the combustion chamber 2 to the second convergent portion in the exhaust ports 3a and 3b (including the convergent exhaust ports 4 and 5) of the first cylinder #1 and the fourth cylinder #4.

The operation of the cylinder head 1 for the multi-cylinder internal combustion engine will now be described.

In the example shown in FIG. 3, the portion where the exhaust ports 3a and 3b of the second cylinder #2 converge (hereinafter referred to as the individual cylinder convergent portion) and the portion where the exhaust ports 3a and 3b of the third cylinder #3 converge (hereinafter referred to as the individual cylinder convergent portion) are located further upstream from the portion corresponding to the first convergent portion of FIG. 1 (hereinafter referred to as the inter-cylinder convergent portion). That is, when referring to the position of the inter-cylinder convergent portion as position PB (corresponding to position P1 in FIG. 1), the position of the individual cylinder convergent portion of each of the cylinders #2 and #3 is located further upstream from position PB. In FIG. 3, the position of the individual cylinder convergent portion of the second cylinder #2 is referred to as position PA. Employment of the structure of the exhaust port shown in FIG. 3 inevitably increases the cross-sectional area of the exhaust ports 3a and 3b of the cylinders #2 and #3 (the total value of the cross-sectional area of the exhaust ports 3a and 3b) in the individual cylinder convergent portion and the inter-cylinder convergent portion.

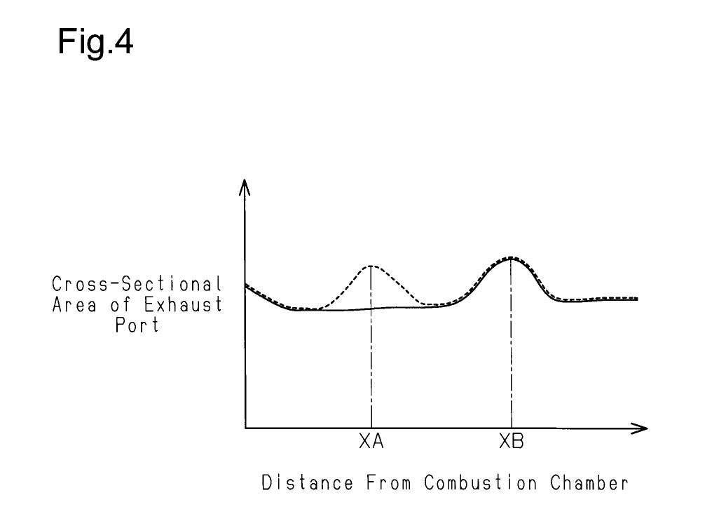

FIG. 4 shows changes in the cross-sectional area of the exhaust ports 3a and 3b (the total value of the cross-sectional area of the two ports) in the second cylinder #2 in correspondence with the distance from the combustion chamber 2 of the second cylinder #2. In FIG. 4, the broken line shows changes in the cross-sectional area when employing the structure of the exhaust port of FIG. 3, and the solid line shows changes in the cross-sectional area when employing the structure of the exhaust port (FIG. 1) of the present embodiment. Distance XA in FIG. 4 represents the distance from the combustion chamber 2 of the second cylinder #2 to position PA (individual cylinder converge portion). Distance XB in FIG. 4 represents the distance from the combustion chamber 2 of the second cylinder #2 to position PB (inter-cylinder convergent portion) or position P1 (first convergent portion).

As shown by the broken line in FIG. 4, when employing the structure of the exhaust port of FIG. 3, the cross-sectional area (total value) of the exhaust ports 3a and 3b in the second cylinder #2 increases at the position of distance XA, then decreases, increases again at the position of distance XB, and decreases afterward. The increase and decrease in the cross-sectional area of the exhaust ports 3a and 3b varies, that is, increases and decreases, the flow velocity of the exhaust flowing through the exhaust ports 3a and 3b. Such a variation, that is, repeated increase and decrease of the flow velocity of exhaust, increases the proportion of the sections where the flow velocity of exhaust decreases in the entire exhaust path. Thus, it is difficult to effectively reduce the temperature of exhaust by increasing the flow velocity of the exhaust.

To solve such a problem, the exhaust ports 3a and 3b of the second cylinder #2 and the exhaust ports 3a and 3b of the third cylinder #3 converge at position P1 in the cylinder head 1 of the present embodiment, as shown in FIG. 1. The cross-sectional area (total value) of the exhaust ports 3a and 3b of the cylinders #2 and #3 increases at position P1 toward the downstream side of the exhaust ports 3a and 3b and then decreases. As shown by the solid line in FIG. 4, the cross-sectional area (total value) of the exhaust ports 3a and 3b of the second cylinder #2 does not increase at the position of distance XA. Instead, the cross-sectional area decreases after increasing at the position of distance XB.

The flow velocity of the exhaust is varied by increases and decreases in the cross-sectional area of the exhaust ports 3a and 3b. In the exhaust port structure of FIG. 1, the flow velocity of the exhaust is varied only once when the exhaust flows through the exhaust ports 3a and 3b of the second cylinder #2 and the third cylinder #3. This limits increases in the proportion of sections where the flow velocity of exhaust decreases in the entire exhaust path, which would be caused by repeated variation, that is, increases and decreases, in the flow velocity of the exhaust flowing through the exhaust ports 3a and 3b. Thus, factors that lower the flow velocity of the exhaust are reduced. This solves the problem that occurs when employing the exhaust port structure of FIG. 3, which would hinder effective reduction of the exhaust temperature when the flow velocity of the exhaust flowing through the exhaust ports 3a and 3b cannot be easily increased.

The present embodiment has the advantages described below.

(1) The exhaust ports 3a and 3b of the second cylinder #2 and the exhaust ports 3a and 3b of the third cylinder #3 in the cylinder head 1 converge at position P1. Thus, in the exhaust flowing through the exhaust ports 3a and 3b of the cylinders #2 and #3, the flow velocity of the exhaust is varied only once, which is caused by increases and decreases in the cross-sectional area of the exhaust ports 3a and 3b. This limits increases in the proportion of sections where the flow velocity of exhaust decreases in the entire exhaust path, which would be caused by repeated variation, that is, increases and decreases, of the flow velocity of the exhaust flowing through the exhaust ports 3a and 3b. Thus, situations in which the flow velocity of exhaust does not increase easily may be avoided. This limits situations in which the temperature of exhaust cannot be effectively reduced when the flow velocity of exhaust flowing in the exhaust ports 3a and 3b cannot be easily increased. The temperature of the exhaust can thus be effectively reduced.

(2) Even when employing the structure of the exhaust port of FIG. 3, as long as the cross-sectional area of the exhaust ports 3a and 3b of the cylinders #2 and #3 is entirely decreased, the flow velocity of exhaust flowing through the exhaust ports 3a and 3b may be increased to further reduce the temperature of the exhaust. However, such a decrease in the cross-sectional area of the exhaust ports 3a and 3b increases the pressure loss in the exhaust ports 3a and 3b. This degrades the scavenged gas of the multi-cylinder internal combustion engine (combustion chamber 2) and lowers the performance of the multi-cylinder internal combustion engine. When employing the exhaust port structure of FIG. 1, such a problem, in which the performance of the multi-cylinder internal combustion engine is lowered, does not occur.

The above embodiment may be modified as follows.

The positional relationship of position P1, where the exhaust ports 3a and 3b of the second cylinder #2 and the third cylinder #3 converge, and position P2, where the convergent exhaust ports 4 and 5 of the first cylinder #1 and the fourth cylinder #4 converge, may be reversed.

The exhaust ports 3a and 3b of the first cylinder #1 may converge at position P2, which is located at the downstream side, and the exhaust ports 3a and 3b of the fourth cylinder #4 may converge at position P2. The convergent portion of the exhaust ports 3a and 3b of the first cylinder #1 corresponds to the convergent portion of the exhaust ports 3a and 3b of the fourth cylinder #4.

The exhaust ports 3a and 3b of the first to fourth cylinders #1 to #4 may all converge at the same position. That is, the eight exhaust ports 3a and 3b, two extending from each of the four cylinders #1 to #4, may converge at the same position.

The number of exhaust ports in each cylinder may be changed to three or more.

The multi-cylinder internal combustion engine does not have to be of an inline type. Instead, the multi-cylinder internal combustion engine may be of a V-type, in which the exhaust ports of the cylinders converge in each bank.

The number of cylinders of the multi-cylinder internal combustion engine may be changed.

### DESCRIPTION OF REFERENCE CHARACTERS

1: cylinder head
2: combustion chamber
3a, 3b: exhaust ports
4, 5: convergent exhaust ports

1. A cylinder head for a multi-cylinder internal combustion engine comprising a plurality of exhaust ports provided for each of a plurality of cylinders arranged in line, wherein:
the plurality of exhaust ports corresponding to each of the plurality of cylinders converge at a convergent portion at a downstream side; and
the exhaust ports respectively corresponding to at least two of the plurality of cylinders converge at the convergent portion.

2. The cylinder head for the multi-cylinder internal combustion engine according to claim 1, comprising four cylinders arranged in line, wherein the exhaust ports corresponding to two middle ones of the four cylinders, in a direction in which the four cylinders are arranged, converge at the convergent portion.

3. The cylinder head for the multi-cylinder internal combustion engine according to claim 2, wherein:
the convergent portion where the exhaust ports corresponding to the two middle cylinders, in the direction in which the four cylinders are arranged, converge is a first convergent portion;
the exhaust ports corresponding to two of the cylinders located at the two ends, in the direction in which the four cylinders are arranged, converge at a second convergent portion, which is located at a downstream side and separated from the first convergent portion in an axial direction of the cylinders; and
a distance from combustion chambers of the two middle cylinders to the first convergent portion is shorter than a distance from combustion chambers of the two end cylinders to the second convergent portion.
